(19) United States
(12) Patent Application Publication
(10) Pub. No.: US 2014/0220255 A1
(43) Pub. Date: Aug. 7, 2014

(54) METHOD FOR PRODUCING PRESSURE-SENSITIVE ADHESIVE SHEET HAVING ULTRAVIOLET-RAY CURING-TYPE ACRYLIC PRESSURE-SENSITIVE ADHESIVE LAYER

(71) Applicant: NITTO DENKO CORPORATION, Osaka (JP)

(72) Inventors: Jun AKIYAMA, Osaka (JP); Tooru NAKASHIMA, Osaka (JP)

(21) Appl. No.: 14/169,727

(22) Filed: Jan. 31, 2014

(30) Foreign Application Priority Data
Feb. 1, 2013 (JP) 2013-018716

(51) Int. Cl. C09J 7/02

(52) U.S. Cl. CPC C09J 7/0217
USPC 427/516

(57) ABSTRACT

Provided is a method for producing a pressure-sensitive adhesive sheet having an ultraviolet-ray curing-type acrylic pressure-sensitive adhesive layer that has a high conversion per unit amount of light, is excellent in productivity, and is also excellent in balance between pressure-sensitive adhesive performances. The method includes: a pressure-sensitive adhesive layer forming step in which the composition is irradiated with and cured by ultraviolet rays to form a pressure-sensitive adhesive layer; wherein an ultraviolet lamp that radiates the ultraviolet rays in the pressure-sensitive adhesive layer forming step is an LED lamp; the ultraviolet rays are radiated intermittently; and the time of bright periods when the ultraviolet rays are radiated is from 1 second to 30 seconds, and the time of dark periods when the rays are not radiated is from 0.1 timed to 20 times the time of the bright periods.

### BACKGROUND OF THE INVENTION

1. Field of the Invention

The present invention relates to a method for producing a pressure-sensitive adhesive sheet having an ultraviolet-ray curing-type acrylic pressure-sensitive adhesive layer.

2. Description of the Related Art

Hitherto, an acrylic pressure-sensitive adhesive has been prepared by subjecting monomer components containing an alkyl acrylate as a main component to solution polymerization. A pressure-sensitive adhesive sheet having a pressure-sensitive adhesive layer has been produced by applying a solvent type pressure-sensitive adhesive onto a substrate, and then drying the resultant workpiece.

In recent years, considering air pollution and environmental problems, known has been a method of photopolymerizing the above-specified monomer components through ultraviolet rays to produce a pressure-sensitive adhesive sheet having an acrylic pressure-sensitive adhesive layer. This method is particularly advantageous from the viewpoint of safety and environment since the method makes it possible to produce the pressure-sensitive adhesive sheet without using any solvent.

As the above-mentioned photopolymerization-used method for producing a pressure-sensitive adhesive sheet or a pressure-sensitive adhesive tape (hereinafter referred to as an pressure-sensitive adhesive sheet), U.S. Pat. No. 4,181,752 discloses a method of applying, onto an appropriate substrate, a composition which contains the above-specified monomer components and a photopolymerization initiator as main components (hereinafter, any composition of the same type will be referred to as a composition, or an ultraviolet-ray curing-type acrylic pressure-sensitive adhesive composition), and then radiating, onto this workpiece, ultraviolet rays having wavelengths of 300 to 400 nm at an irradiance of 7 mW/cm² or less to yield a pressure-sensitive adhesive sheet. In this method, the radiation of the ultraviolet rays, which gives the relatively low irradiance, makes a polymer made from the monomer components into a high molecular weight, thereby increasing the cohesive strength of the pressure-sensitive adhesive layer (of the sheet). In such a way, a pressure-sensitive adhesive sheet can be obtained which is high in holding power at high temperature. Although the pressure-sensitive adhesive sheet yielded has an advantage that its pressure-sensitive adhesive layer is improved in cohesive strength, the polymerization velocity becomes small so that the method causes a problem of productivity under conditions of radiating the ultraviolet rays at the low irradiance. By contrast, under conditions of radiating the ultraviolet rays at a high irradiance, the polymerization velocity is improved; however, radicals are rapidly consumed. As a result, a polymer made from the monomer components is lowered in molecular weight so that the pressure-sensitive adhesive sheet cannot be made high in holding power at high temperature.

Against these problems, JP-B-7-53849 and JP-A-7-331198 each disclose a method of radiating ultraviolet rays initially onto the above-specified monomer components at a low irradiance to cause at least 80% of the quantity of the monomer components, and then radiating ultraviolet rays onto the workpiece at a higher irradiance than the initial irradiance, whereby the method is improved in productivity while the resultant pressure-sensitive adhesive layer keeps a high cohesive strength. However, the method cannot solve the following problem: ultraviolet rays are radiated at a low irradiance until most of the polymerization reaction is finished; thus, the method requires a longer polymerization reaction period than the method of radiating ultraviolet rays at a high irradiance, so as to be poorer in productivity.

### PRIOR ART DOCUMENTS

### Patent Documents

Patent Document 1: U.S. Pat. No. 4,181,752

Patent Document 2: JP-B-7-53849

Patent Document 3: JP-A-7-331198

### SUMMARY OF THE INVENTION

The present invention has been made to solve the problem, and an objective thereof is to provide a method for producing a pressure-sensitive adhesive sheet having an ultraviolet-ray curing-type acrylic pressure-sensitive adhesive layer that has a high conversion per unit amount of light, is excellent in productivity, and is also excellent in balance between pressure-sensitive adhesive performances, such as holding power at high temperature.

In order to solve the problems, the inventors have made eager investigations to find out that the object can be attained by a method described below for producing a pressure-sensitive adhesive sheet having an ultraviolet-ray curing-type acrylic pressure-sensitive adhesive layer. This finding has led to the completion of the invention.

The present invention relates to a method for producing a pressure-sensitive adhesive sheet, the method comprising: an applying step in which an ultraviolet-ray curing-type acrylic pressure-sensitive adhesive composition containing at least a monomer-component matter that is/contains an alkyl (meth)acrylate, and/or a partial polymer made from the monomer-component matter, and a photopolymerization initiator, is applied onto a substrate; a pressure-sensitive adhesive layer forming step in which the pressure-sensitive adhesive composition is irradiated with and cured by ultraviolet rays to form a pressure-sensitive adhesive layer; wherein an ultraviolet lamp that radiates the ultraviolet rays in the pressure-sensitive adhesive layer forming step is an LED lamp, the ultraviolet rays are radiated intermittently, the time of bright periods when the ultraviolet rays are radiated is from 1 second to 30 seconds, and the time of dark periods when the rays are not radiated is from 0.1 times to 20 times the time of the bright periods.

An irradiance of the ultraviolet rays is 20 mW/cm² or more.

The peak wavelength of the ultraviolet rays of the invention is in a range from 200 nm to 500 nm.

The monomer-component matter comprises a polyfunctional monomer.

One type of the ultraviolet lamp that radiates the ultraviolet rays is used in the pressure-sensitive adhesive layer forming step.

### EFFECTS OF THE INVENTION

According to the invention, the LED lamp used as the ultraviolet lamp is lower in emission heat than other ultraviolet lamps so that it is possible to restrain a rise in the temperature of the pressure-sensitive adhesive layer during the polymerization. Accordingly, this makes it possible to prevent the polymer from being lowered in molecular weight so that the pressure-sensitive adhesive layer is prevented from being deteriorated in cohesive strength and the pressure-sensitive adhesive sheet is enhanced in holding power at high temperature. The ultraviolet rays are radiated intermittently in the method to be able to preferentially advance the growth reaction process of the radical polymerization and produce polymers having a higher molecular weight. Further, light is radiated for a time that is necessary to increase the polymerization velocity per unit amount of light. Therefore, the method is excellent in productivity. Because the radiation of the ultraviolet rays in the method gives relatively high irradiance (20 mW/cm²), the polymerization at high velocity is possible. Therefore, the method is excellent in productivity.

### DETAILED DESCRIPTION OF THE PREFERRED EMBODIMENTS

Hereinafter, a description will be made about a method according to an embodiment of the invention for producing a pressure-sensitive adhesive sheet having an ultraviolet-ray curing-type acrylic pressure-sensitive adhesive layer.

An ultraviolet-ray curing-type acrylic pressure-sensitive adhesive composition used in the present embodiment is a composition comprising a photopolymerization initiator, and a monomer-component matter that is/comprises an alkyl(meth)acrylate and/or a partial polymer made from the monomer-component matter. The composition is a composition which is applied onto a substrate, and then irradiated with ultraviolet rays, thereby undergoing the polymerization of the monomer-component matter therein, so as to be turned to an ultraviolet-ray curing-type acrylic pressure-sensitive adhesive layer.

The alkyl(meth)acrylate used in the embodiment may be, for example, an alkyl(meth)acrylate having a linear or branched alkyl group having about 1 to 20 carbon atoms, preferably an alkyl(meth)acrylate having a linear or branched alkyl group having about 2 to 14 carbon atoms. Specific examples thereof include methyl(meth)acrylate, ethyl(meth)acrylate, propyl(meth)acrylate, isopropyl(meth)acrylate, n-butyl(meth)acrylate, isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate. In the present specification, the wordings “(meth)acrylate” and “(meth)acrylic” mean “acrylate and/or methacrylate” and “acrylic and/or methacrylic”, respectively.

The alkyl(meth)acrylate other than the above-mentioned alkyl(meth)acrylate, which has a linear or branched alkyl group, is preferably, for example, an alkyl(meth)acrylate having an alicyclic hydrocarbon group, such as cyclopentyl(meth)acrylate, a cycloalkyl(meth)acrylate or isobornyl(meth)acrylate.

The monomer-component matter used in the embodiment may be made of a single alkyl(meth)acrylate, or a mixture of plural alkyl(meth)acrylates. The monomer-component matter may also be a mixture of an alkyl(meth)acrylate and any other copolymerizable monomer. Further, a partial polymer made from the monomer-component matter may be used in the embodiment.

In the embodiment, the alkyl(meth)acrylate(s) is/are (each) used as the whole or a main component of the monomer-component matter, which is to constitute the ultraviolet-ray curing-type acrylic pressure-sensitive adhesive layer, Thus, the content by percentage thereof is 60% or more by weight, preferably 80% or more by weight of the whole of the monomer-component matter, which is to constitute the pressure-sensitive adhesive layer.

In order that the ultraviolet-ray curing-type acrylic pressure-sensitive adhesive layer used in the invention can be improved in adhering strength onto an adherend, cohesive strength, heat-resistance, and other properties, this pressure-sensitive adhesive layer may contain, besides the alkyl(meth)acrylate(s), a polar-group-containing monomer copolymerizable therewith as one component of the monomer-component matter, which is to constitute the pressure-sensitive adhesive layer.

Examples of the polar-group-containing monomer include carboxyl-group-containing monomers, such as (meth)acrylic acid, carboxyethyl(meth)acrylate, carboxypentyl(meth)acrylate, itaconic acid, maleic acid, fumaric acid, crotonic acid, and isocrotonic acid; acid anhydride monomers such as maleic anhydride, and itaconic anhydride; hydroxyl-group-containing monomers such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxymethylcyclohexyl)methyl (meth)acrylate; sulfonate-group-containing monomers such as styrenesulfonic acid, allylsulfonic acid, 2-(meth)acrylamide-2-methylpropanesulfonic acid, (meth)acrylamidepropanesulfonic acid, sulfopropyl(meth)acrylate, and (meth)acryloyloxynaphthalenesulfonic acid; phosphate-group-containing monomers such as 2-hydroxyethylacryloyl phosphate; amide-group-containing monomers such as acrylamide, methacrylamide, N,N-dimethyl(meth)acrylamide, N-methylol(meth)acrylamide, N-methoxymethyl(meth)acrylamide, and N-butoxymethyl(meth)acrylamide; amino-group-containing monomers such as aminoethyl(meth)acrylate, dimethylaminoethyl(meth)acrylate, and t-butylaminoethyl(meth)acrylate; glycidyl-group-containing monomers such as glycidyl(meth)acrylate, and methylglycidyl(meth)acrylate; cyano-group-containing monomers such as acrylonitrile, and methacrylonitrile; and heterocyclic-ring-containing vinyl monomers such as N-vinylpyridine, N-vinylpiperidone, N-vinylpyrimidine, N-vinylpiperazine, N-vinylpyrrole, N-vinylimidazole, and N-vinyloxazole. These copolymerizable monomers may be used alone or in combination of two or more thereof.

The use amount by percentage of the polar-group-containing monomer is 30% or less by weight of the whole of the monomer-component matter, preferably from 3% by weight thereof to 20% by weight thereof. If the use amount by percentage is more than 30% by weight, for example, the pressure-sensitive adhesive layer may become too high in cohesive strength to be unfavorably declined in adhesive strength.

For the adjustment of the cohesive strength of the pressure-sensitive adhesive layer, the pressure-sensitive adhesive layer may contain a polyfunctional monomer which is a bifunctional or higher functional monomer, as one component of the monomer-component matter, which is to constitute the ultraviolet-ray curing-type acrylic pressure-sensitive adhesive layer, besides the above-mentioned components.

Examples of the polyfunctional monomer include trimethylolpropane tri(meth)acrylate, pentaerythritol di(meth)acrylate, pentaerythritol tri(meth)acrylate, pentaerythritol tetra(meth)acrylate, dipentaerythritol hexa(meth)acrylate, 1,2-ethylene glycol di(meth)acrylate, 1,6-hexanediol(meth)acrylate, 1,12-dodecanediol di(meth)acrylate, (poly)ethylene glycol di(meth)acrylate, (poly)propylene glycol di(meth)acrylate, neopentyl glycol di(meth)acrylate, tetramethylolmethane tri(meth)acrylate, allyl(meth)acrylate, vinyl(meth)acrylate, divinylbenzene, epoxy acrylate, polyester acrylate, and urethane acrylate.

The use amount by percentage of the polyfunctional monomer is 2% or less by weight of the whole of the monomer-component matter, preferably from 0.02% by weight thereof to 1% by weight thereof. If the use amount by percentage is more than 2% by weight, for example, the pressure-sensitive adhesive layer becomes too high in cohesive strength to be possibly declined in adhesive strength.

Examples of the copolymerizable monomer (as one component of the monomer-component matter) other than the polar-group-containing monomer and the polyfunctional monomer that constitute the ultraviolet-ray curing-type acrylic pressure-sensitive adhesive layer include vinyl esters such as vinyl acetate, and vinyl propionate; aromatic vinyl compounds such as vinylbenzene, and vinyltoluene; olefins or dienes such as ethylene, butadiene, isoprene, and isobutylene; vinyl ethers such as vinyl alkyl ethers; vinyl chloride; alkoxyalkyl(meth)acrylate monomers such as methoxyethyl(meth)acrylate, and ethoxyethyl(meth)acrylate; imide-group-containing monomers such as cyclohexylmaleimide, and isopropylmaleimide; isocyanate-group-containing monomers such as 2-methacryloyloxyethylisocyanate; fluorine-atom-containing (meth)acrylates; and silicon-atom-containing (meth)acrylates. The use amount by percentage of the copolymerizable monomer is preferably 40% by weight or less, and more preferably 30% by weight or less of the whole of the monomer-component matter. If the use amount is more than 40% by weight, the cohesive strength becomes too high, and possibly declined in tackiness, in particular, at normal temperature. The lower limit of the use amount by percentage of the copolymerizable monomer is not particularly limited. However, if the use amount is less than 0.1% by weight, for example, it is difficult to obtain the effects of the copolymerizable monomer.

The ultraviolet-ray curing-type acrylic adhesive composition contains a photopolymerization initiator. The photopolymerization initiator is not particularly limited as far as the initiator is a substance which can generate radicals by irradiation with ultraviolet rays to initiate photopolymerization. Any one of ordinarily used photopolymerization initiators can be preferably used, examples thereof including benzoin ether based, acetophenone based, α-ketol based, optically active oxime based, benzoin based, benzil based, benzophenone based, ketal based, thioxanthone based, and acylphosphine oxide based photopolymerization initiators.

Specific examples of the benzoin ether based photopolymerization initiators include benzoin methyl ether, benzoin ethyl ether, benzoin propyl ether, benzoin isopropyl ether, benzoin isobutyl ether, 2,2-dimethoxy-1,2-diphenylethane-1-one, and anisole methyl ether.

Examples of the acetophenone based photopolymerization initiators include 2,2-diethoxyacetophenone, 2,2-dimethoxy-2-phenylacetophenone, 1-hydroxycyclohexyl phenyl ketone, 4-phenoxydichloroacetophenone, and 4-t-butyldichloroacetophenone.

Examples of the α-ketol based photopolymerization initiators include 2-methyl-2-hydroxypropiophenone, and 1-[4-(2-hydroxyethyl)phenyl]-2-hydroxy-2-methylpropane-1-one.

Examples of the optically active oxime based photopolymerization initiators include 1-phenyl-1,1-propanedione-2-(o-ethoxycarbonyl)-oxime.

Examples of the benzoin based photopolymerization initiators include benzoin.

Examples of the benzil based photopolymerization initiators include benzil.

Examples of the benzophenone based photopolymerization initiators include benzophenone, benzoylbenzoic acid, 3,3′-dimethyl-4-methoxybenzophenone, polyvinylbenzophenone, and α-hydroxycyclohexyl phenyl ketone.

Examples of the ketal based photopolymerization initiators include benzyl dimethyl ketal.

Examples of the thioxanthone based photopolymerization initiators include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and dodecylthioxanthone.

Examples of the acylphosphine oxide based photopolymerization initiator include 2,4,6-trimethylbenzoyl-diphenyl-phosphine oxide, and bis(2,4,6-trimethylbenzoyl)-phenylphosphine oxide.

The use amount of the photopolymerization initiator is not particularly limited. The use amount by percentage is from 0.01% by weight to 5% by weight, and preferably from 0.03% by weight to 3% by weight of the whole of the monomer-component matter. If the use amount by percentage of the photopolymerization initiator is less than 0.01% by weight, the photopolymerization reaction may become insufficient. If the use amount by percentage of the photopolymerization initiator is more than 5% by weight, the resultant polymer may be lowered in molecular weight so that the pressure-sensitive adhesive layer may be deteriorated in cohesive strength. The aforementioned photopolymerization initiator can be used alone or in combination of two or more thereof.

In the embodiment, an appropriate additive, besides the monomer-component matter and the photopolymerization initiator, may be incorporated into the ultraviolet-ray curing-type acrylic adhesive composition in accordance with the use purpose thereof. Examples of the additive include crosslinking agents (such as polyisocyanate based, silicone based, epoxy based, and alkyl-etherized melamine based crosslinking agents); tackifiers (such as rosin derivative resin, polyterpene resin, petroleum resin, oil-soluble phenolic resin, and other tackifiers in a solid, semisolid or liquid format normal temperature); fillers such as hollow glass balloons; plasticizers; anti-aging agents; and antioxidants. A colorant, such as a pigment or dye, may be incorporated thereinto as far as the colorant does not hinder the photopolymerization.

In the embodiment, it is preferred to adjust the ultraviolet-ray curing-type acrylic pressure-sensitive adhesive composition into a viscosity appropriate for the work of applying the composition onto a substrate, or a work similar thereto. The adjustment of the viscosity of this composition is attained, for example, by adding a polymer, a polyfunctional monomer or an analogue that may be of various types, such as a polymeric thickening additive, or by subjecting the monomer-component matter in the ultraviolet-ray curing-type acrylic adhesive composition to partial polymerization. The partial polymerization may be conducted before or after the addition of the polymer, the polyfunctional monomer or the analogue that may be of various types, such as a polymeric thickening additive. The viscosity of the ultraviolet-ray curing-type acrylic pressure-sensitive adhesive composition may also be varied in accordance with the amount of the additive, or other factors. When the monomer-component matter in the ultraviolet-ray curing-type acrylic adhesive composition is partially polymerized, the conversion to be attained cannot be decided without reservation. For reference, the conversion is preferably 20% or less, more preferably 15% or less. If the conversion is more than 20%, the polymer becomes too high in viscosity so that the composition is not easily applied onto a substrate.

In the embodiment, the ultraviolet-ray curing-type acrylic pressure-sensitive adhesive composition is applied onto a substrate for a pressure-sensitive adhesive sheet.

The substrate used in the embodiment, for a pressure-sensitive adhesive sheet, maybe a substrate that may be of various materials, for example, a synthetic resin film such as a polyester film, or a fibrous substrate.

The method for applying the ultraviolet-ray curing-type acrylic pressure-sensitive adhesive composition onto the substrate is not particularly limited, and may be a known appropriate method such as roll coating, bar coating or die coating.

In the embodiment, the ultraviolet-ray curing-type acrylic pressure-sensitive adhesive composition is applied onto a surface or both surfaces of the substrate, and then ultraviolet rays are radiated to this ultraviolet-ray curing-type acrylic pressure-sensitive adhesive composition to photopolymerize the monomer-component matter in the ultraviolet-ray curing-type acrylic pressure-sensitive adhesive composition to form an ultraviolet-ray curing-type acrylic pressure-sensitive adhesive layer. In this way, a pressure-sensitive adhesive sheet is produced.

In the present embodiment, the irradiance of the ultraviolet rays radiated on the ultraviolet-ray curing-type acrylic pressure-sensitive adhesive composition is preferably 20 mW/cm² or more, and more preferably 25 mW/cm² or more. If the irradiance of the ultraviolet rays is less than 20 mW/cm², the polymerization reaction period becomes long so that the pressure-sensitive adhesive sheet may be poor in productivity. The irradiance of the ultraviolet rays is preferably 200 mW/cm² or less. If the irradiance of the ultraviolet rays is more than 200 mW/cm², the photopolymerization initiator is abruptly consumed so that the polymer is lowered in molecular weight. Thus, the holding power may be deteriorated, in particular, at high temperature.

The ultraviolet lamp used in the present embodiment is preferably an LED lamp. The LED lamp is lower in emission heat than other ultraviolet lamps so that it possible to restrain a rise in the temperature of the pressure-sensitive adhesive layer during the polymerization. Accordingly, the LED lamp makes it possible to prevent the polymer from being lowered in molecular weight so that the pressure-sensitive adhesive layer is prevented from being deteriorated in cohesive strength and the pressure-sensitive adhesive sheet is enhanced in holding power at high temperature.

In the present embodiment, the ultraviolet rays are intermittently radiated to produce bright periods when the ultraviolet rays are radiated, and dark periods when not radiated. In the present embodiment, at least two times or more of the bright periods are provided.

In general, the reaction rate of each of steps (initial reaction, growth reaction, and termination reaction) of the radical polymerization reaction of a polymer is represented by the following equations:

Initial reaction rate: R₁=2fK_{d}[I]

Growth reaction rate: Rₚ=kₚ[M·][M]

Termination reaction rate: Rₜ=kₜ[M·]²

where f is the initial reaction efficiency, k_{d} is the decomposition rate constant, [I] is the concentration of the photopolymerization initiator, kₚ is the growth rate constant, [M·] is the radical concentration, [M] is the monomer concentration, and kₜ is the termination reaction rate constant.

In the polymerization of the ultraviolet-ray curing-type acrylic pressure-sensitive adhesive composition, the photopolymerization initiator is cleaved by the ultraviolet rays so that the polymerization includes an initial reaction (a bright reaction) that is carried out by the ultraviolet rays and a growth reaction (a dark reaction) that is not carried out by the ultraviolet rays. The bright reaction is a reaction between radicals so that the reaction rate is faster than that of the dark reaction, and the dark reaction becomes the rate-determining reaction when the ultraviolet rays are continuously radiated. Therefore, excessive cleaving of the photopolymerization initiator occurs by the ultraviolet rays that are radiated when the dark reaction is not completed, and a large amount of radicals are generated. The rate of the termination reaction is increased by the generation of radicals to cause the polymer being lowered in molecular weight.

On the other hand, when the ultraviolet rays are intermittently radiated, excessive cleaving of the photopolymerization initiator is suppressed so that the polymer is suppressed from being lowered in molecular weight. Further, light is radiated for a time that is necessary to increase the polymerization velocity per unit amount of light.

The time when the ultraviolet rays are radiated in the bright periods is preferably from 1 second to 30 seconds, and more preferably from 3 seconds to 20 seconds. If the time when the ultraviolet rays are radiated in the bright periods is more than 30 seconds, the reaction becomes the same polymerization reaction as when the ultraviolet rays are continuously radiated, and polymers having a higher molecular weight may not be produced. If the time when the ultraviolet rays are radiated in the bright periods is less than 1 second, there is less cleaving of the initiator per one bright period, and the photopolymerization reaction may be insufficient.

In the present embodiment, the time of the dark periods is preferably from 0.1 times to 20 times the time of the bright periods, and more preferably from 0.5 times to 10 times. If the time of the dark periods is not less than 0.1 times the time of the bright periods, it is not preferable because the growth reaction does not proceed sufficiently during the dark periods to cause the pressure-sensitive adhesive being lowered in molecular weight. If the time of the dark periods is more than 20 times the time of the bright periods, it is not preferable because it takes a long time for the polymer to become a composition, and the productivity decreases.

In the present embodiment, a drying step in a drying oven may be provided after the radiation of the ultraviolet rays. The final conversion of the monomer-component matter in the ultraviolet-ray curing-type acrylic pressure-sensitive adhesive composition is preferably 95% or more, and more preferably 97% or more. If the conversion is less than 95%, deterioration of the pressure-sensitive adhesive sheet property may be caused.

Considering the productivity, the total amount of radiation of the ultraviolet rays that is necessary for the conversion of the monomer-component matter in the ultraviolet-ray curing-type acrylic pressure-sensitive adhesive composition after the radiation of the ultraviolet rays to become 95% or more is preferably from 1,000 mJ/cm² to 15,000 mJ/cm², and more preferably from 5,000 mJ/cm² to 10,000 mJ/cm². If the total amount of radiation is less than 1,000 mJ/cm², the photopolymerization reaction may be insufficient. If the total amount of radiation is more than 15,000 mJ/cm², it is not preferable because it takes a long time for the polymer to become a composition, and the productivity decreases. Considering the productivity, the time that is necessary for the final conversion of the monomer-component matter in the ultraviolet-ray curing-type acrylic pressure-sensitive adhesive composition to become 95% or more is preferably 600 seconds or less, and more preferably 480 seconds or less.

A plurality of cycles of the bright periods and the dark periods may be provided. The plurality of cycles of the bright periods and the dark periods are repeated to improve the conversion of the pressure-sensitive adhesive while suppressing the excessive cleaving of the photopolymerization initiator. If the plurality of cycles of the bright periods and the dark periods are provided, the time of the bright periods and the time of the dark periods in each cycle may be changed.

In the present embodiment, simplicity of the facility and simplicity of the maintenance are considered, and only one type of ultraviolet lamp is preferably used.

In the present embodiment, the peak wavelength of the ultraviolet rays radiated on the ultraviolet-ray curing-type acrylic pressure-sensitive adhesive composition is preferably in the range from 200 nm to 500 nm, and more preferably in the range from 300 nm to 450 nm. If the peak wavelength of the ultraviolet rays is more than 500 nm, the photopolymerization initiator is not decomposed so that the polymerization reaction may not be initiated. If the peak wavelength of the ultraviolet rays is less than 200 nm, the polymer chains are cleaved so that the adhesive layer may be deteriorated in adhesive property.

The irradiance of ultraviolet rays is measured, using a measuring instrument, “UV Power Pack (trade name)”, manufactured by EIT Inc.

The reaction is hindered by oxygen in the air. Thus, in order to block oxygen, it is preferred to form a release film or an analogue thereof onto a layer based on the application of the acrylic adhesive composition, or conduct the photopolymerization reaction in the atmosphere of nitrogen. A release treatment agent (release agent) used when a release film or an analogue thereof is formed onto a substrate on which the application-based layer is to be formed may be, for example, a silicone release agent, or a long-chain-alkyl containing release agent.

The pressure-sensitive adhesive sheet of the embodiment may be produced by using a release paper piece as the substrate, forming an ultraviolet-ray curing-type acrylic pressure-sensitive adhesive layer onto the release paper piece, and then transferring this ultraviolet-ray curing-type acrylic pressure-sensitive adhesive layer onto another substrate.

The thickness of the pressure-sensitive adhesive sheet produced in the production method of the present embodiment is not particularly limited, and is preferably adjusted to set the thickness of its pressure-sensitive adhesive layer into the range of 0.01 mm to 10 mm, particularly, 0.02 mm to 5 mm. If the thickness of the adhesive layer is more than 10 mm, ultraviolet rays do not easily transmit the layer so that it takes much time to polymerize the monomer-component matter. Thus, the adhesive sheet may be poor in productivity.

### EXAMPLES

Hereinafter, the invention will be described in detail by way of examples; however, the invention is never limited by these examples.

### Preparation of Acrylic Polymer Syrup 1:

Into a four-necked flask were charged 90 parts by weight of 2-ethylhexyl acrylate (2EHA), 10 parts by weight of acrylic acid, 0.05 parts by weight of a photopolymerization initiator 1-hydroxy-cyclohexyl-phenyl-ketone (trade name: Irgacure 184, manufactured by BASF Corporation), and 0.05 parts by weight of a photopolymerization initiator 2,2-dimethoxy-1,2-diphenylethan-1-one (trade name: Irgacure 651, manufactured by BASF Corporation). The mixture was exposed to ultraviolet rays in the atmosphere of nitrogen to photopolymerize the monomer-component matter therein partially, thus yielding a partial polymer (acrylic polymer syrup 1) having a conversion of 7% by weight.

### Preparation of Acrylic Polymer Syrup 2:

A photopolymerization was performed in the same way as used for the acrylic polymer syrup 1 except that the photopolymerization initiator for the acrylic polymer syrup 1 was changed to 0.1 parts by weight of an initiator “Irgacure 184”, thus yielding a partial polymer (acrylic polymer syrup 2) having a conversion of 8% by weight.

### Preparation of Acrylic Polymer Syrup 3:

A photopolymerization was performed in the same way as used for the acrylic polymer syrup 1 except that the photopolymerization initiator for the acrylic polymer syrup 1 was changed to 0.1 parts by weight of an initiator 2-methyl-1[4-(methylthio)phenyl]-2-morpholinopropan-1-one (trade name: Irgacure 907, manufactured by BASF Corporation), thus yielding a partial polymer (acrylic polymer syrup 3) having a conversion of 9% by weight.

### Preparation of Acrylic Polymer Syrup 4:

A photopolymerization was performed in the same way as used for the acrylic polymer syrup 1 except that the photopolymerization initiator for the acrylic polymer syrup 1 was changed to 0.1 parts by weight of an initiator “Irgacure 651”, thus yielding a partial polymer (acrylic polymer syrup 4) having a conversion of 8% by weight.

### Example 1

### Preparation of Ultraviolet-Ray Curing-Type Acrylic Pressure-Sensitive Adhesive Composition:

To 100 parts by weight of the acrylic polymer syrup 1 was added 0.04 parts by weight of 1,6-hexanediol diacrylate. These were then mixed with each other into a homogenous state to prepare an ultraviolet-ray curing-type acrylic pressure-sensitive adhesive composition.

### Production of Pressure-Sensitive Adhesive Sheet:

Prepared was a polyester film (trade name: MRF, manufactured by Mitsubishi Polyester Film Inc.) having a surface releasing-agent treated with silicone and having a thickness of 38 μm. An applicator was used to paint the ultraviolet-ray curing-type acrylic pressure-sensitive adhesive composition onto the releasing-agent-treated surface to give a final thickness of 60 μm, thus forming a painted layer. Next, the surface of the painted adhesive composition was covered with the same 38-μm-thickness polyester film (trade name: MRN, manufactured by Mitsubishi Polyester Film Inc.) to locate the releasing-agent-treated surface of this film at the painted-surface side of the workpiece. In this way, the painted layer of the adhesive composition was blocked from oxygen. The thus-obtained pressure-sensitive adhesive sheet was intermittently irradiated with ultraviolet rays having an irradiance of 75 mW/cm² at wavelengths of 320 nm to 390 nm from an LED lamp (manufactured by Hamamatsu Photonics K.K.) having a peak wavelength of 365 nm. At this time, the time of the bright periods when the ultraviolet rays were radiated was 6 seconds, and the time of the dark periods when the ultraviolet rays were not radiated was 10 seconds. This cycle of bright periods and dark periods was repeated until the total amount of radiation reached 9,000 mJ/cm² to photopolymerize the monomer-component matter contained in the ultraviolet-ray curing-type acrylic pressure-sensitive adhesive composition, so that a pressure-sensitive adhesive sheet was yielded.

### Example 2

A pressure-sensitive adhesive sheet was produced in the same way as in Example 1 except that the acrylic polymer syrup 1 was changed to the acrylic polymer syrup 2.

### Example 3

A pressure-sensitive adhesive sheet was produced in the same way as in Example 1 except that the acrylic polymer syrup 1 was changed to the acrylic polymer syrup 3.

### Example 4

A pressure-sensitive adhesive sheet was produced in the same way as in Example 1 except that: the acrylic polymer syrup 1 was changed to the acrylic polymer syrup 2; an LED lamp (manufactured by EYE GRAPHICS Co., Ltd.) having a peak wavelength of 375 nm was used as the ultraviolet lamp; and the cycle of the bright periods and the dark periods, in which the time of the bright periods was 12 seconds and that of the dark periods was 10 seconds, was repeated until the total amount of radiation reached 9,000 mJ/cm².

### Example 5

A pressure-sensitive adhesive sheet was produced in the same way as in Example 1 except that: the acrylic polymer syrup 1 was changed to the acrylic polymer syrup 4; an LED lamp (manufactured by Hamamatsu Photonics K.K.) having a peak wavelength of 385 nm was used as the ultraviolet lamp; ultraviolet rays having an irradiance of 30 mW/cm² at wavelengths of 320 nm to 390 nm were radiated; and the cycle of the bright periods and the dark periods, in which the time of the bright periods was 6 seconds and that of the dark periods was 10 seconds, was repeated until the total amount of radiation reached 4,000 mJ/cm².

### Example 6

A pressure-sensitive adhesive sheet was produced in the same way as in Example 1 except that: an LED lamp (manufactured by Hamamatsu Photonics K.K.) having a peak wavelength of 385 nm was used as the ultraviolet lamp; ultraviolet rays having an irradiance of 30 mW/cm² at wavelengths of 320 nm to 390 nm were radiated; and the cycle of the bright periods and the dark periods, in which the time of the bright periods was 6 seconds and that of the dark periods was 10 seconds, was repeated until the total amount of radiation reached 4,000 mJ/cm².

### Comparative Example 1

A pressure-sensitive adhesive sheet was produced in the same way as in Example 1 except that: the acrylic polymer syrup 1 was changed to the acrylic polymer syrup 2; a metal halide lamp (manufactured by HARRISON TOSHIBA LIGHTING Corporation) was used as the ultraviolet lamp; and the cycle of the bright periods and the dark periods, in which the time of the bright periods was 8 seconds and that of the dark periods was 10 seconds, was repeated until the total amount of radiation reached 6,000 mJ/cm².

### Comparative Example 2

A pressure-sensitive adhesive sheet was produced in the same way as in Example 1 except that: the acrylic polymer syrup 1 was changed to the acrylic polymer syrup 3; a non-electrode lamp (trade name: M Bulb, manufactured by Fusion UV Systems Japan K.K.) was used as the ultraviolet lamp; and the cycle of the bright periods and the dark periods, in which the time of the bright periods was 4 seconds and that of the dark periods was 10 seconds, was repeated until the total amount of radiation reached 6,000 mJ/cm².

### Comparative Example 3

A pressure-sensitive adhesive sheet was produced in the same way as in Example 1 except that: the acrylic polymer syrup 1 was changed to the acrylic polymer syrup 4; a metal halide lamp (manufactured by HARRISON TOSHIBA LIGHTING Corporation) was used as the ultraviolet lamp; and the cycle of the bright periods and the dark periods, in which the time of the bright periods was 6 seconds and that of the dark periods was 15 seconds, was repeated until the total amount of radiation reached 9,000 mJ/cm².

### Comparative Example 4

A pressure-sensitive adhesive sheet was produced in the same way as in Example 1 except that: the acrylic polymer syrup 1 was changed to the acrylic polymer syrup 2; an LED lamp (manufactured by HOYA CANDEO OPTRONICS CORPORATION) having a peak wavelength of 365 nm was used as the ultraviolet lamp; ultraviolet rays having an irradiance of 75 mW/cm² were continuously radiated until the total amount of radiation reached 9,000 mJ/cm².

### Comparative Example 5

A pressure-sensitive adhesive sheet was produced in the same way as in Example 1 except that: the acrylic polymer syrup 1 was changed to the acrylic polymer syrup 2; an LED lamp (manufactured by HOYA CANDEO OPTRONICS CORPORATION) having a peak wavelength of 385 nm was used as the ultraviolet lamp; ultraviolet rays having an irradiance of 14 mW/cm² were continuously radiated until the total amount of radiation reached 2,500 mJ/cm².

The pressure-sensitive adhesive sheets were each evaluated by the following methods:

### Conversion:

The weight (X₁g) of a sample from the sheet which was to be measured about the conversion thereof was measured, and the sample was dried at 130° C. for 2 hours. The weight (X₂g) of the sample was again measured. From the weights X₁g and X₂g, the conversion was calculated in accordance with “conversion (%)=(X₂/X₁)×100”.

### Heat-Resistant Holding Power:

One of releasing-liners (polyester films) of the pressure-sensitive adhesive sheet was peeled off, and the adhesive sheet was bonded to a polyethylene terephthalate film of 50 μm thickness. The resultant was cut into a width of 10 mm to forma sample tape. A releasing-liner was peeled off from the other adhesive surface of the sample tape. The sample tape was bonded onto a bakelite plate as an adherend to have a bonded area of 10 mm width and 29 mm length by reciprocating a 2 kg roller one time onto the plate. This was allowed to stand still in an environment of 80° C. temperature for 30 minutes, and then the bakelite plate was vertically hung to give a load of 500 g to a free end of the sample piece. The sample was allowed to stand still in an environment of 80° C. temperature for 2 hours in the state that the load was given. When the sample dropped in a 2 hours or less, the time up to the dropping was measured. When the sample adhered onto the adherend without dropping after the 2 hours, the length (mm) of the shift of the sample from the initially sample-adhering position was measured. When the shift length of the sample tape was less than 2.0 mm in this case the sample tape was judged to be good. When the sample tape gave a shift length of 2 .0 mm or more, or dropped, the sample tape was judged to be bad.

Results of this evaluation are shown in Table 1. In Examples 1 to 6, it was confirmed that the conversion after the radiation by the ultraviolet rays was 95% or more, that a high conversion per unit amount of light was obtained, which resulted in an excellent productivity, and that each of the pressure-sensitive adhesive sheets of Examples 1 to 6 had an excellent holding power at high temperature.

TABLE 1

| | | | Bright | Dark | Total amount | Conversion after | Heat-resistant |
|---|---|---|---|---|---|---|---|
| | Ultraviolet | Irradiance | periods | periods | of radiation | Radiation by | holding power |
| | lamp species | (mW/cm²) | (seconds) | (seconds) | (mJ/cm²) | Ultraviolet Rays (%) | shift-length (mm) |
| Example 1 | LED | 75 | 6 | 10 | 9000 | 99 (good) | 0.9 (good) |
| Example 2 | LED | 75 | 6 | 10 | 9000 | 99 (good) | 0.1 (good) |
| Example 3 | LED | 75 | 6 | 10 | 9000 | 97 (good) | 0.1 (good) |
| Example 4 | LED | 75 | 12 | 10 | 9000 | 99 (good) | 0.9 (good) |
| Example 5 | LED | 30 | 6 | 10 | 4000 | 98 (good) | 0.1 (good) |
| Example 6 | LED | 30 | 6 | 10 | 4000 | 97 (good) | 0.2 (good) |
| Comparative | Metal halide | 75 | 8 | 10 | 6000 | 99 (good) | Dropped in 101 |
| Example 1 | | | | | | | minutes (bad) |
| Comparative | M Bulb | 75 | 4 | 10 | 6000 | 98 (good) | Dropped in 38 |
| Example 2 | | | | | | | minutes (bad) |
| Comparative | Metal halide | 75 | 6 | 15 | 9000 | 92 (bad) | Dropped in 52 |
| Example 3 | | | | | | | minutes (bad) |
| Comparative | LED | 75 | 120 | 0 | 9000 | 98 (good) | Dropped in 86 |
| Example 4 | | | | | | | minutes (bad) |
| Comparative | LED | 14 | 180 | 0 | 2500 | 85 (bad) | Dropped in 41 |
| Example 5 | | | | | | | minutes (bad) |

1. A method for producing a pressure-sensitive adhesive sheet, the method comprising:
an applying step in which an ultraviolet-ray curing-type acrylic pressure-sensitive adhesive composition containing at least a monomer-component matter that contains an alkyl (meth)acrylate, and/or a partial polymer made from the monomer-component matter, and a photopolymerization initiator, is applied onto a substrate;
a pressure-sensitive adhesive layer forming step in which the pressure-sensitive adhesive composition is irradiated with and cured by ultraviolet rays to form a pressure-sensitive adhesive layer;
wherein an ultraviolet lamp that radiates the ultraviolet rays in the pressure-sensitive adhesive layer forming step is an LED lamp;
the ultraviolet rays are radiated intermittently; and
the time of bright periods when the ultraviolet rays are radiated is from 1 second to 30 seconds, and the time of dark periods when the rays are not radiated is from 0.1 timed to 20 times the time of the bright periods.

2. The method for producing a pressure-sensitive adhesive sheet according to claim 1, wherein an irradiance of the ultraviolet rays is 20 mW/cm² or more.

3. The method for producing a pressure-sensitive adhesive sheet according to claim 1, wherein a peak wavelength of the ultraviolet rays is in a range from 200 nm to 500 nm.

4. The method for producing a pressure-sensitive adhesive sheet according to claim 1, wherein the monomer-component matter comprises a polyfunctional monomer.

5. The method for producing a pressure-sensitive adhesive sheet according to claim 1, wherein the ultraviolet lamp that radiates the ultraviolet rays in the pressure-sensitive adhesive layer forming step is one type.

6. The method for producing a pressure-sensitive adhesive sheet according to claim 1, wherein an irradiance of the ultraviolet rays is 200 mW/cm² or less.

7. The method for producing a pressure-sensitive adhesive sheet according to claim 2, wherein an irradiance of the ultraviolet rays is 200 mW/cm² or less.

8. The method for producing a pressure-sensitive adhesive sheet according to claim 1, wherein a total amount of irradiation of the ultraviolet rays is 1,000 J/cm² to 15,000 J/cm².

9. The method for producing a pressure-sensitive adhesive sheet according to claim 1, wherein a total amount of time for 95% or more conversion of the monomer-component matter in the ultraviolet-ray curing-type acrylic pressure-sensitive adhesive composition is 600 seconds or less.
